(19) United States
(12) Patent Application Publication
(10) Pub. No.: US 2006/0033554 A1
(43) Pub. Date: Feb. 16, 2006

(54) Charge pump circuit

(76) Inventors: Hiroyuki Matsunami, Kasugai (JP); Kouji Okada, Kasugai (JP); Takaaki Ido, Kumaki (JP)

Correspondence Address: ARENT FOX PLLC, 1050 CONNECTICUT AVENUE, N.W., SUITE 400, WASHINGTON, DC, 20036, US

(21) Appl. No.: 11/234,379

(22) Filed: Sep. 26, 2005

Related U.S. Application Data
(63) Continuation of application No. PCT/JP03/09185, filed on Jul. 18, 2003.

(51) Int. Cl. G05F 1/10

(52) U.S. Cl. 327/536

(57) ABSTRACT

A charge pump circuit is disclosed in which a spike-shaped noise (glitch) generated in an output is reduced. The charge pump circuit comprises: a first transistor, one of the terminals of which is connected to a high electric potential power source, turned on and off according to a charge-up signal; a second transistor, one of the terminals of which is connected to a low electric potential power source, turned on and off according to a charge-down signal; a first current restricting element connected between the other terminal of the first transistor and the output of a charge pump; and a second current restricting element connected between the other terminal of the second transistor and the output of the charge pump.

This application is a continuation of International Application No. PCT/JP03/09185, filed on Jul. 18, 2003, which International Application was published by the International Bureau, in Japanese, on Jan. 27, 2005.

### FIELD OF THE INVENTION

The present invention relates to a charge pump circuit for charging up and down an electrical charge with respect to a loop filter by using a phase difference detection signal, which is sent from a phase detecting circuit, as an input signal in PLL (Phase Locked Loop) circuit.

### BACKGROUND OF THE INVENTION

In order to generate a clock of a predetermined phase and of a predetermined frequency from a reference clock signal inputted from the outside, the PLL (Phase Locked Loop) circuit is commonly used. FIG. 1 is a view showing a fundamental constitution of the PLL circuit for generating a clock CK, the frequency of which is M/N times as high as that of the reference clock CLK, from the reference clock CLK. This circuit includes: 1/N frequency divider 11; a frequency phase comparator 12; a charge pump (CP) circuit 13; a loop filter 14; a voltage control oscillator (VCO) 15; and 1/M frequency divider 16. The loop filter 14 has a resistor and capacitor which are connected in series to each other between the output node of the charge pump 13 and the ground. The frequency phase comparator 12 detects a phase difference between CLK, the frequency of which is divided by 1/N, and CK, the frequency of which is divided by 1/M, and outputs a signal for controlling the charge pump circuit 13 according to the phase difference. The charge pump circuit 13 outputs a signal for charging or discharging the loop filter 14, and a difference voltage is generated at one end of the loop filter 14 according to the phase difference. This difference voltage is impressed upon VCO 15, and VCO 15 generates a clock CK of a constant period corresponding to the difference voltage.

The present invention relates to a charge pump circuit used for the above PLL circuit.

FIG. 2 is a view showing an example of the arrangement of the conventional charge pump circuit. As shown in FIG. 2, the charge pump circuit includes: PMOS transistor TR1 connected between the constant current source 21, which is connected to a high electric potential power source, and the output terminal, and controlled being turned on and off by the charge-up signal UP; and NMOS transistor TR2 connected between the constant current source 22, which is connected to a low electric potential power source, and the output terminal, and controlled being turned on and off by the charge-down signal DW. The charge-up signal UP is “High (H)” in the normal state, and the charge-down signal DW is “Low (L)” in the normal state.

When the frequency phase comparator 12 judges that the frequency of the clock CK is lower than the frequency of the reference clock CLK, a control signal for changing the charge-up signal UP to “Low (L)” is outputted. According to that, PMOS transistor TR1 is turned on, and NMOS transistor TR2 is turned off. Therefore, a charging output for charging the output terminal is obtained from the high electric potential power source via the constant current power source 21. Due to this charging output, the capacity of the loop filter 14 is electrically charged, and the difference voltage is raised and the oscillation frequency of VCO1 is increased. When the frequency phase comparator 12 judges that the frequency of the clock CK is higher than the frequency of the reference clock CLK, a control signal for changing the charge-down signal DW to “High (H)” is outputted. According to that, PMOS transistor TR1 is turned off, and NMOS transistor TR2 is turned on. Therefore, a discharging output is obtained which conducts discharging from the output terminal to the low electric potential power source via the constant current source 22. Due to this discharging output, the capacity of the loop filter 14 is discharged and the difference voltage is lowered, and the oscillation frequency of VCO 15 is decreased. The pulse width of the charge-up signal UP and that of the charge-down signal DW are changed according to the state of synchronization of two clocks in PLL circuit. For example, in the case where a difference between the frequency of the clock CLK and the frequency of the clock CK is large, that is, in the case where the state of synchronization is not good, a pulse width of the charge-up signal UP or the charge-down signal DW is extended, and an intensity of the charging and discharging current flowing in the unit time is increased. In the case where the difference between the frequency of the clock CLK and the frequency of the clock CK is small, that is, in the case where the state of synchronization is good, and the frequency and the phase are locked, a pulse width of the charge-up signal UP or the charge-down signal DW is reduced, and an intensity of the charging and discharging current flowing in the unit time is decreased.

In the charge pump circuit shown in FIG. 2, the charge-up signal UP is impressed upon the gate terminal of PMOS transistor TR1, and the charge-down signal DW is impressed upon the gate terminal of NMOS transistor TR2. As shown in the drawing, the parasite capacity PC1 is formed between the gate of PMOS transistor TR1 and the drain, and the parasite capacity PC2 is formed between the gate of NMOS transistor TR2 and the drain. In the case where the gate voltage is changed, a spike-shaped noise (a glitch) is generated in the output signal by the coupling of the parasite capacities PC1 and PC2.

FIGS. 4A and 4B are views showing a state of the generation of this glitch. When the charge-up signal UP is changed as shown by the curve A in the graph of FIG. 4A, the output current is changed as shown by the curve B in the graph of FIG. 4B, that is, a large glitch is generated. With respect to the charge-down signal DW, a glitch is generated in the output current in the same manner.

When a glitch is generated in the output current, the following problems may be encountered. When a glitch is generated in the output current, a glitch (noise) is also generated in the difference voltage, and the clock CK generated by VCO 15 becomes unstable. Especially, in the case where the state of synchronization of two clocks in PLL circuit is improved as described above and the frequency and phase are locked, the pulse width of the charge-up signal UP and that of the charge-down signal DW become very narrow. In accordance with the reduction of the pulse width, the glitch greatly affects the converging property of PLL circuit and the fluctuation of the clock CK generated by PLL circuit is increased.

### DISCLOSURE OF THE INVENTION

An object of the present invention is to realize a charge pump circuit in which the generation of a glitch is decreased.

FIG. 3 is a view showing a fundamental constitution of the charge pump circuit of the present invention. As shown in FIG. 3, the charge pump circuit of the present invention is composed as follows. In the conventional charge pump circuit shown in FIG. 2, the first current restricting element 23 is provided between the first transistor TR1 and the charge pump output, and the second current restricting element 24 is provided between the second transistor TR2 and the charge pump output.

The charge pump circuit of the present invention is preferably applied to PLL circuit shown in FIG. 1.

According to the present invention, when the charge-up signal UP and the charge-down signal DW are changed by the electric current restricting elements 23, 24, an instantaneous change in the current, which is caused by the coupling of the parasite capacities PC1 and PC2 formed between the gate and the drain, is restricted ands absorbed. Due to the foregoing, a spike-shaped noise (glitch) of the charge pump output can be reduced. In the charge pump circuit of the present invention, when the charge-up signal UP is changed as shown by the curve A of FIG. 4A, the output signal is changed as shown by the curve C of FIG. 4B. When the curves C and B are compared with each other, it can be understood that the glitch generated in the present invention becomes lower than the glitch generated in the prior art. In this connection, concerning the glitch generated by the charge-down signal DW, the glitch can be reduced in the same manner.

The first and the second current restricting element can be composed of, for example, transistors of PMOS type and NMOS type. The gate of PMOS type transistor may be connected to the low electric potential power source (ground), however, the first bias level may be impressed upon the gate. The gate of NMOS transistor may be connected to the high electric potential power source, however, the second bias level may be impressed. When the first and the second bias level are impressed, it is possible to obtain a higher current restricting effect.

When the bias level generating circuit for generating the first and the second bias level is composed of a cascade current mirror circuit, the charging current and the discharging current can be made to be the same with each other.

In the charge pump circuit in which a plurality of small charge pump circuits are arranged in parallel to each other and the outputs of the plurality of small charge pump circuits are connected in common and the plurality of small charge pump circuits are respectively driven by a plurality of charge-up signals and charge-down signals, the aforementioned charge-pump circuit is used for the small charge pump circuit. Then, the generation of a glitch can be reduced in the same manner.

In this connection, the official gazette of JP-A-7-7402 discloses an arrangement in which a current restricting element is provided in an inverter circuit provided in the front stage of an output circuit. However, according to this circuit disclosed in the above publicly known example, voltage in the output circuit is negatively fed back to the output of the inverter circuit, and even when a different load capacity is driven, the output wave-form is made to be constant. Therefore, the object of the circuit of the above publicly known example is different from that of the present invention. Further, the current restricting element is provided in the inverter circuit in the front stage, and the current restricting element is not provided in the output circuit for driving the load capacity. Therefore, the constitution of the above publicly known example is different from that of the present invention. Furthermore, according to this circuit, a change of the signal impressed upon the transistor gate composing the output circuit becomes loose by an influence of the capacity used for negative feedback control. Therefore, when this circuit is used for the charge pump circuit, problems will be caused in the operation.

### BRIEF DESCRIPTION OF THE DRAWINGS

FIG. 1 is a view showing an example of the arrangement of PLL circuit.

FIG. 2 is a view showing an arrangement of the conventional charge pump circuit, wherein an influence of the parasite capacity is explained in this view.

FIG. 3 is a view showing a fundamental arrangement of the charge pump circuit of the present invention.

FIGS. 4A and 4B are views showing an example of the glitch generated in the charge pump circuits of the conventional example and the present invention.

FIG. 5 is a view showing an arrangement of the charge pump circuit of the first embodiment of the present invention.

FIG. 6 is a view showing an arrangement of the charge pump circuit of the second embodiment of the present invention.

FIG. 7 is a view showing an arrangement of the charge pump circuit of the third embodiment of the present invention.

FIG. 8 is a view showing an arrangement of the charge pump circuit of the fourth embodiment of the present invention.

FIG. 9 is a view showing an arrangement of the charge pump circuit of the fifth embodiment of the present invention.

FIG. 10 is a view showing an arrangement of the charge pump circuit of the sixth embodiment of the present invention.

### THE MOST PREFERRED EMBODIMENT

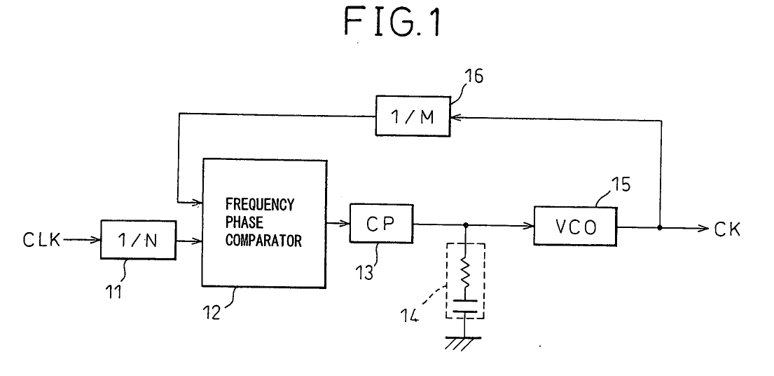

An embodiment of the present invention will be explained below. The charge pump circuit of this embodiment is preferably applied to PLL circuit shown in FIG. 1.

FIG. 5 is a view showing an arrangement of the charge pump circuit of the first embodiment of the present invention. As shown in the view, the charge pump circuit of the first embodiment includes: a constant current source 21, PMOS transistor TR1 and a first current restricting PMOS transistor R1 which are connected in series to each other between the high electric potential power source and the output terminal; and a constant current source 22, NMOS transistor TR2 and a second current restricting NMOS transistor R2 which are connected in series to each other between the low electric potential power source and the output terminal. A charge-up signal Up is impressed upon the gate of PMOS transistor TR1, a charge-down signal DW is impressed upon the gate of NMOS transistor TR2, a gate of the first current restricting PMOS transistor R1 is connected to the ground, and a gate of the second current restricting NMOS transistor R2 is connected to the high electric potential power source. Due to the foregoing, the first current restricting PMOS transistor R1 and the second current restricting NMOS transistor R2 are operated as resistors.

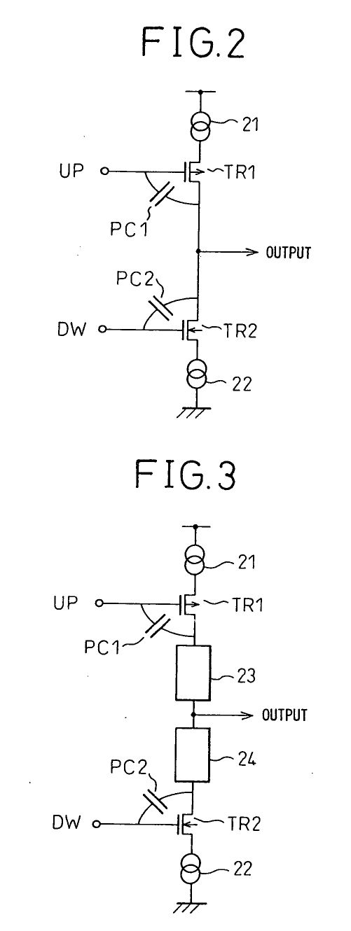

In other words, the charge pump circuit of the first embodiment is different from the conventional charge pump circuit shown in FIG. 2 as follows. In the charge pump circuit of the first embodiment, the first current restricting transistor R1 is arranged between the drain of PMOS type transistor TR1 and the charge pump output terminal, and the second current restricting transistor R2 is arranged between the drain of NMOS type transistor TR2 and the charge pump output terminal. The first current restricting transistor R1 corresponds to the first current restricting element 23 shown in FIG. 3, and the second current restricting transistor R2 corresponds to the second current restricting element 24 shown in FIG. 3.

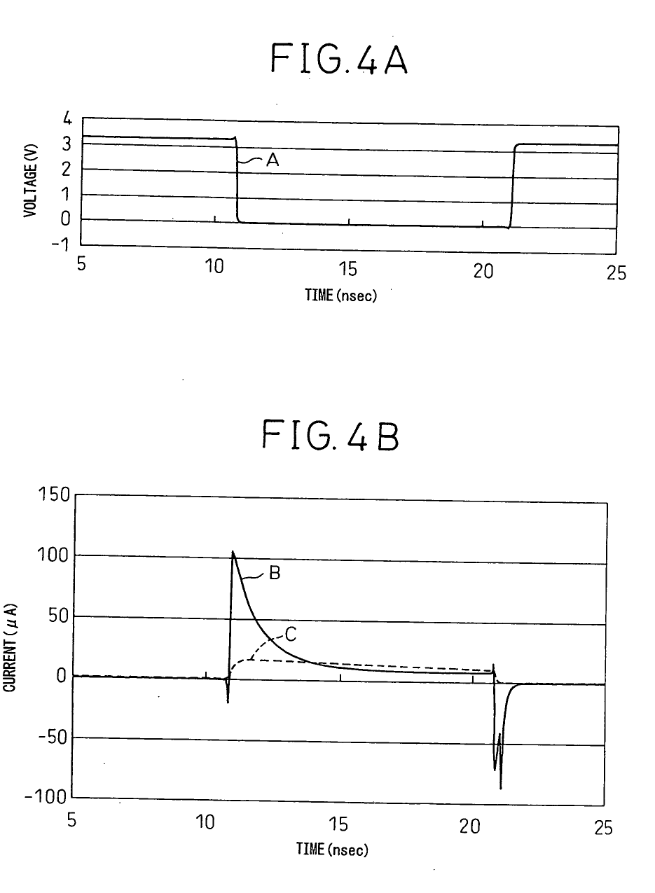

In the charge pump circuit of the first embodiment, when the charge-up signal UP changes as shown in FIG. 4A, PMOS transistor TR1 is changed to the state of ON, and a current flows from the high electric potential power source via the constant current circuit 21. At this time, an electric potential on the drain side is instantaneously raised because of the parasite capacity formed between the gate of TR1 and the drain. However, in the charge pump circuit of the first embodiment, a change in the current is suppressed by the first current restricting transistor R1 connected between the drain of TR1 and the output terminal of the charge pump. Accordingly, an influence caused by the change in the drain voltage is suppressed. Therefore, the output of the charge pump is changed as shown by the curve C in FIG. 4B and the generation of a glitch is reduced, that is, the glitch is substantially eliminated. A glitch generated according to the change in the charge-down signal DW is reduced by the second current restricting transistor R2 in the same manner.

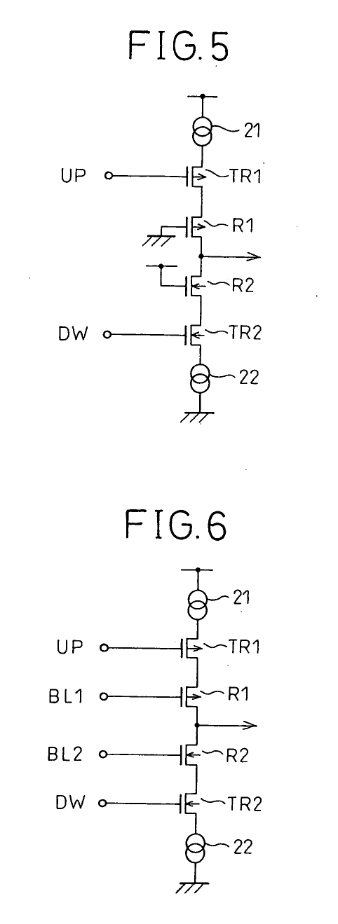

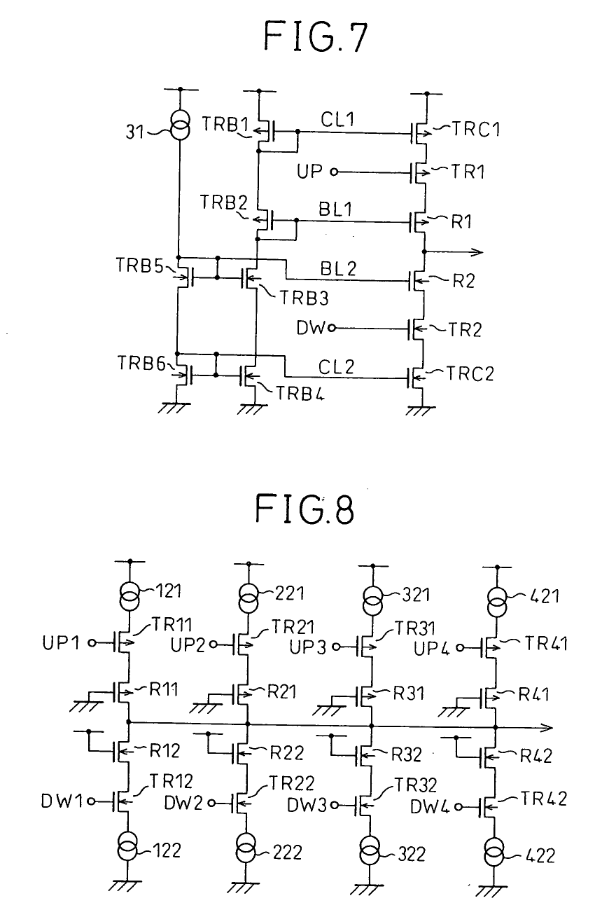

FIG. 6 is a view showing an arrangement of the charge pump circuit of the second embodiment of the present invention. The charge pump circuit of the second embodiment is different from the charge pump circuit of the first embodiment as follows. In the second embodiment, the first bias level BL1 is impressed upon the gate of the first current restricting PMOS transistor R1, and the second bias level BL2 is impressed upon the gate of the second current restricting NMOS transistor R2.

When the electric potential of the gate of PMOS transistor is maintained to be higher than that of the source, PMOS transistor is electrically continued and operated as a resistor, and the resistance is changed according to the electric potential impressed upon the gate. In the first embodiment, since the gate of the first current restricting PMOS transistor R1 is connected to the low electric potential power source (ground), the resistance becomes relatively low. Therefore, in the first embodiment, it is impossible for the first current restricting PMOS transistor R1 to provide a sufficiently high current restricting effect. On the other hand, in the second embodiment, when the bias level BL1, which is impressed upon the gate of the first current restricting PMOS transistor R1, is appropriately set, it becomes possible to set the resistance of the first current restricting PMOS transistor R1 at an appropriate value.

Therefore, the current restricting effect can be enhanced, and the generation of a glitch in the output of the charge pump can be further reduced. The circumstances are the same in the case of the second current restricting NMOS transistor R2. When the bias level BL2 to be impressed upon the gate is appropriately set, the resistance of the second current restricting NMOS transistor R2 can be set at an appropriate value, and the generation of a glitch can be further reduced.

FIG. 7 is a view showing an arrangement of the charge pump circuit of the third embodiment of the present invention. The charge pump circuit of the third embodiment is different from the charge pump circuit of the second embodiment as follows. In the third embodiment, the bias level generation circuit for generating the first bias level BL1 and the second bias level BL2 is provided, and the constant power sources 21 and 22 are realized by specific transistor circuits. The bias level generation circuit is a cascade current mirror circuit. The cascade current mirror circuit includes: a constant current source 31; PMOS transistors TRB1 and TRB2; and NMOS transistors TRB3 to TRBG. The bias level generation circuit generates predetermined voltage CL1, CL2, BL1 and BL2. BL1 and BL2 are respectively impressed upon the gates of the first current restricting PMOS transistor R1 and the second current restricting NMOS transistor R2.

The constant current source 21 is connected between the high electric potential power source and the source of PMOS transistor TR1 and composed of PMOS transistor TRC1, upon the gate of which voltage CL1 described above is impressed. The constant current source 22 is connected between the constant electric potential power source and the source of NMOS transistor TR2 and composed of NMOS transistor TRC2, upon the gate of which voltage CL2 described above is impressed. Due to the above constitution, the first current restricting PMOS transistor R1 is operated so that a current, the intensity of which is substantially the same as that of the current made to flow by PMOS transistor TRC1, can be made to flow. The second current restricting NMOS transistor R2 is also operated so that a current, the intensity of which is substantially the same as that of the current made to flow by NMOS transistor TRC2, can be made to flow.

FIG. 8 is a view showing an arrangement of the charge pump circuit of the fourth embodiment of the present invention. As shown in the view, in the charge pump circuit of the fourth embodiment, four small charge pump circuits are arranged in parallel to each other and the outputs of the four small charge pump circuits are connected in common. Each small charge pump circuit is composed in the same manner as that of the charge pump circuit of the first embodiment shown in FIG. 5. The first small charge pump circuit includes: a first current source 121; PMOS transistor TR11; a first current restricting PMOS transistor R11; a second current restricting NMOS transistor R12; NMOS transistor TR12; and a constant current source 122. The second to the fourth small charge pump circuit are composed in the same manner, and the explanations are omitted here.

The first to the fourth small charge pump circuit are respectively impressed with charge-up signals UP1, UP2, UP3 and UP4 and charge-down signals DW1, DW2, DW3 and DW4.

Intensities of the currents charged by and discharged from the first to the fourth small charge pump circuit are respectively different from each other. For example, intensities of the currents charged by and discharged from the first to the fourth small charge pump circuit are assumed to be 1:2:4:8. In this case, when the effective combinations of the charge-up signals UP1, UP2, UP3 and UP4 with the charge-down signals DW1, DW2, DW3 and DW4 are selected, the intensity of the current charging and discharging can be changed into 15 stages. For example, if the intensity of the current of charging and discharging is 1 when only UP1 and DW1 are made to be effective, in the case where all the charge-up signals and the charge-down signals are made to be effective, the intensity of the current of charging and discharging is 16.

In the arrangement of the fourth embodiment, when the first current restricting PMOS transistor and the second current restricting NMOS transistor are provided, the generation of a glitch in the output can be reduced.

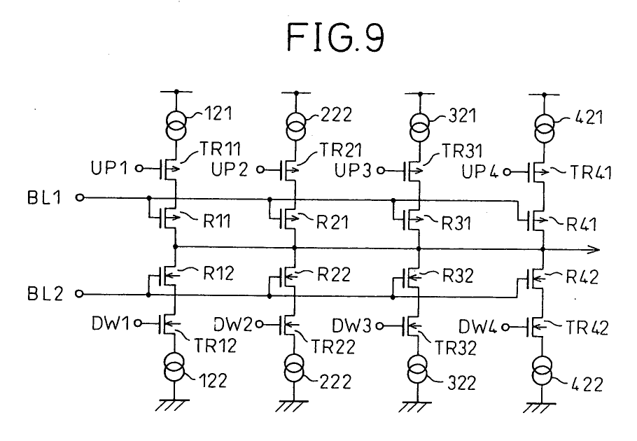

FIG. 9 is a view showing an arrangement of the charge pump circuit of the fifth embodiment of the present invention. As shown in the view, in the same manner as that of the fourth embodiment, the charge pump circuit of the fifth embodiment includes four small charge pump circuits which are arranged in parallel to each other, and the outputs of these four small charge pump circuits are connected in common. The constitution of each small charge pump circuit is the same as that of the charge pump circuit of the second embodiment shown in FIG. 6. In this case, the same effect as that of the second embodiment can be provided.

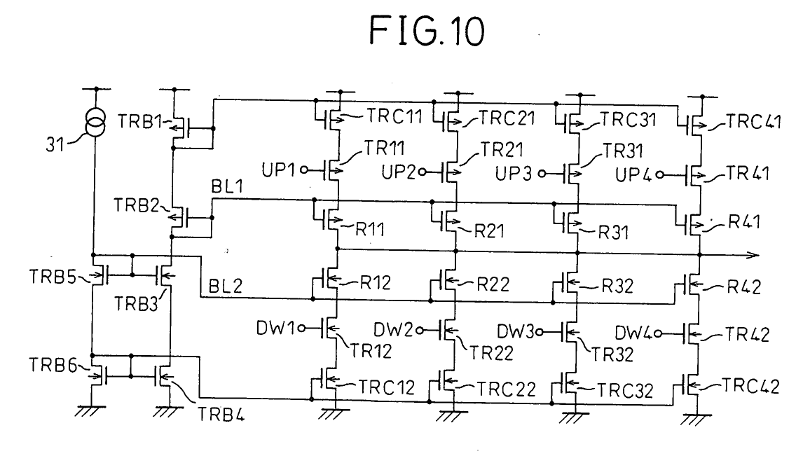

FIG. 10 is a view showing an arrangement of the charge pump circuit of the sixth embodiment of the present invention. As shown in the view, in the same manner as that of the fourth embodiment, the charge pump circuit of the sixth embodiment is composed in such a manner that four small charge pump circuits are arranged in parallel to each other and the outputs are connected in common. The constitution of each charge pump circuit is the same as that of the charge pump circuit of the third embodiment shown in FIG. 7. In this case, the same effect as that of the third embodiment can be provided.

Embodiments of the present invention are explained above. However, it should be noted that the present invention is not limited to the above specific embodiments and variations may be made by those skilled in the art.

### INDUSTRIAL APPLICABILITY

According to the present invention, it is possible to reduce a glitch generated in a charge pump circuit used for PLL circuit. Due to the reduction of generation of the glitch, the converging characteristic and the fluctuation characteristic of PLL circuit can be improved.

1. A charge pump circuit comprising:
a first transistor, one of the terminals of which is connected to a high electric potential power source, turned on and off according to a charge-up signal;
a second transistor, one of the terminals of which is connected to a low electric potential power source, turned on and off according to a charge-down signal;
a first current restricting element connected between the other terminal of the first transistor and the output of a charge pump; and
a second current restricting element connected between the other terminal of the second transistor and the output of the charge pump.

2. A charge pump circuit having a plurality of small charge pump circuits, which are arranged in parallel to each other, the outputs of which are connected in common, wherein
the plurality of small charge pump circuits are respectively driven by a plurality of charge-up signals and charge-down signals,
each charge pump circuit comprising:
a first transistor, one of the terminals of which is connected to a high electric potential power source, turned on and off according to each charge-up signal;
a second transistor, one of the terminals of which is connected to a low electric potential power source, turned on and off according to each charge-down signal;
a first current restricting element connected between the other terminal of the first transistor and the output of a charge pump; and
a second current restricting element connected between the other terminal of the second transistor and the output of the charge pump.

3. A charge pump circuit according to claim 1, wherein
the first current restricting element is PMOS type transistor, the gate of which is connected to the low electric potential power source, and
the second current restricting element is NMOS type transistor, the gate of which is connected to the high electric potential power source.

4. A charge pump circuit according to claim 1, wherein
the first current restricting element is PMOS type transistor, upon the gate of which the first bias level is impressed,
the second current restricting element is NMOS type transistor, upon the gate of which the second bias level is impressed, and
the charge pump circuit includes a bias level generation circuit for generating the first and the second bias level.

5. A charge pump circuit according to claim 4, wherein the bias level generation circuit includes a cascade current mirror circuit.

6. A charge pump circuit according to claim 2, wherein
the first current restricting element is PMOS type transistor, upon the gate of which the first bias level is impressed, and
the second current restricting element is NMOS type transistor, upon the gate of which the second bias level is impressed.

7. A charge pump circuit according to claim 6, further comprising a bias level generation circuit for generating the first and the second bias level.

8. A charge pump circuit according to claim 6, the first and the second bias level are common among the plurality of small charge pump circuits, and
the bias level generation circuit generates the first and the second bias level which are common.

9. A charge pump circuit according to claim 7, wherein the bias level generation circuit includes a cascade current mirror circuit.

10. A charge pump circuit according to claim 2, wherein
the first current restricting element is PMOS type transistor, the gate of which is connected to the low electric potential power source, and
the second current restricting element is NMOS type transistor, the gate of which is connected to the high electric potential power source.

11. A charge pump circuit according to claim 8, wherein the bias level generation circuit includes a cascade current mirror circuit.
